(19) United States
(12) Patent Application Publication
(10) Pub. No.: US 2004/0208451 A1
(43) Pub. Date: Oct. 21, 2004

(54) Method and apparatus for monitoring optical signals in a planar lightwave circuit via out-of-plane filtering

(76) Inventors: Anders Grunnet-Jepsen, San Jose, CA (US); Alan Johnson, San Jose, CA (US); John N. Sweetser, San Jose, CA (US)

Correspondence Address: Lance A. Termes, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/141,894

(22) Filed: May 8, 2002

(51) Int. Cl. H04B 10/08; H04B 10/12

(52) U.S. Cl. 385/47

(57) ABSTRACT

A method, apparatus, and system for monitoring optical signals in a planar lightwave circuit (“PLC”) by tapping light from an optical transmission medium (e.g., a waveguide or optical fiber), into which a grating has been written, out of a plane of the optical transmission medium and onto a photosensitive device are disclosed herein. In one embodiment, a tilted grating, with an angle greater than about 6 degrees from normal to a central axis of the optical transmission medium may be written into a waveguide in the PLC at a location at which an attribute (e.g., a wavelength or power) of an optical signal is to be measured. A portion of an optical signal may then be reflected out of a plane of the optical transmission medium, and be detected by a photodetector positioned in a second plane, distinct from the plane of the optical transmission medium.

### TECHNICAL FIELD

This disclosure relates generally to planar lightwave circuits, and more particularly, but not exclusively, to a method, apparatus, and system for monitoring optical signals in a planar lightwave circuit by tapping light from an optical transmission medium, into which a grating has been written, out of a plane of the optical transmission medium onto a photosensitive device.

### BACKGROUND INFORMATION

With the continued growth of the Internet and multimedia communications, the demand for increased capacity on networks has fueled the evolution and use of optical fibers. In an effort to optimize the data carrying capacity of optical fiber networks, planar lightwave circuits (“PLCs”) are becoming an increasingly sophisticated and integral element.

PLCs generally comprise a layered structure including a region of higher refractive index material sandwiched between outer layers of lower refractive index material. The layer of higher refractive index material may be designed to create a circuit comprised of a plurality of waveguides to, for example, add, switch, or filter different wavelengths of light. In some cases, PLCs may be used as a bridge between electrical components that generate data for transmission on, or receive data from, an optical fiber network. In these cases, the PLCs may provide a wavelength division multiplexing function, for example, to increase the carrying capacity of the coupled optical fiber network, or to de-multiplex incoming optical signals to allow for the detection and/or manipulation of data encoded in the diverse frequencies propagating through the optical fiber network.

Whatever the function of the PLCs, current techniques for monitoring the power and/or wavelength of the optical signal, or optical signals, propagating through the waveguides at one or more points within the circuit present a challenge to designers. Current techniques for monitoring optical signals in the waveguides of the PLC include routing a waveguide (e.g., the waveguide having the signal to be monitored, or an additional waveguide that may contain a portion of the light from the waveguide having the signal to be monitored) to an edge of the PLC where the light may be detected by a photodetector. While effective, routing waveguides to the edges of the PLC not only increases the complexity of the circuit design, including consideration of issues relating to crossing-waveguides, but also consumes a portion of the available “real estate” on the PLC. Moreover, routing waveguides to the edges of the PLC generally comprises a part of a fabrication process, thereby prompting a predetermination regarding which points in the circuit to monitor, prior to fabrication of the PLC.

### BRIEF DESCRIPTION OF THE VARIOUS VIEWS OF THE DRAWINGS

In the drawings, like reference numerals refer to like parts throughout the various views of the non-limiting and non-exhaustive embodiments of the present invention, and wherein:

FIG. 1 is a partially exploded, cut-away view, illustrating an example PLC and an example detector substrate showing a portion of an optical signal being tapped out of a plane of an optical transmission medium in accordance with an embodiment of the present invention;

FIG. 2 is a block diagram illustration of an embodiment of an apparatus for monitoring optical signals in a PLC in accordance with an embodiment of the present invention;

FIG. 3 is a cross-sectional view, taken substantially along line 3-3 of FIG. 1, illustrating a relationship between an example grating written into an example optical transmission medium and an example photodetector in accordance with an embodiment of the present invention;

FIG. 4 is a cross-sectional view, like FIG. 3, illustrating embodiments of a blazed grating and a photodetector in accordance with an embodiment of the present invention;

FIG. 5 is a cross-sectional view, like FIG. 3, illustrating embodiments of a chirped grating and a photodetector array in accordance with an embodiment of the present invention;

FIG. 6 is a cross-sectional view, like FIG. 3, illustrating embodiments of a phase-shifted grating and a photodetector in accordance with an embodiment of the present invention;

FIGS. 7A and 7B are cross-sectional views, like FIG. 3, illustrating embodiments of a blazed grating, a planar optical element, and a photodetector array in accordance with an embodiment of the present invention;

FIG. 8 is a cross-sectional view, like FIG. 3, illustrating an effect of lengthening an example grating in accordance with an embodiment of the present invention;

FIG. 9 is a flow diagram illustrating an example flow of events in a process for monitoring an attribute of an optical signal propagating through an optical transmission medium in accordance with an embodiment of the present invention; and

FIG. 10 is a block diagram illustration of an example optical system in accordance with an embodiment of the present invention.

### DETAILED DESCRIPTION OF THE ILLUSTRATED EMBODIMENTS

Embodiments of a method, apparatus, and system for monitoring optical signals in a PLC via out-of-plane filtering are described in detail herein. In the following description, numerous specific details are provided, such as the identification of various system components, to provide a thorough understanding of embodiments of the invention. One skilled in the art will recognize, however, that embodiments of the invention can be practiced without one or more of the specific details, or with other methods, components, materials, etc. In still other instances, well-known structures, materials, or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, embodiments of the invention provide a method, apparatus, and system for monitoring optical signals in a PLC by tapping light from an optical transmission medium (e.g., a waveguide, optical fiber, or the like), into which a grating has been written, out of a plane of the optical transmission medium and onto a photosensitive device (e.g., a photodetector). In one representative embodiment, a tilted grating, with an angle greater than about 6 degrees from normal to a central axis of the optical transmission medium may be written into a waveguide in the PLC at a location at which an attribute (e.g., power or wavelength) of an optical signal is to be measured. Depending on the strength and orientation of the grating, at least a portion of the optical signal may be tapped (e.g., via diffraction) out of the waveguide at an angle to cause the at least a portion of the optical signal to travel out of the plane of the waveguide. The at least a portion of the optical signal may then be detected by a photodetector or other photosensitive device, in an embodiment, positioned in a second plane distinct from the plane of the waveguide. In one embodiment, a chirped grating or planar optical element, both of which will be discussed in greater detail hereinafter, may be used to map one or more wavelengths of light (comprising a part of the optical signal) into a spatial position in a Fourier plane (e.g., on a photodetector array) to aid in monitoring the wavelength(s) and/or power of the optical signal propagating through the waveguide.

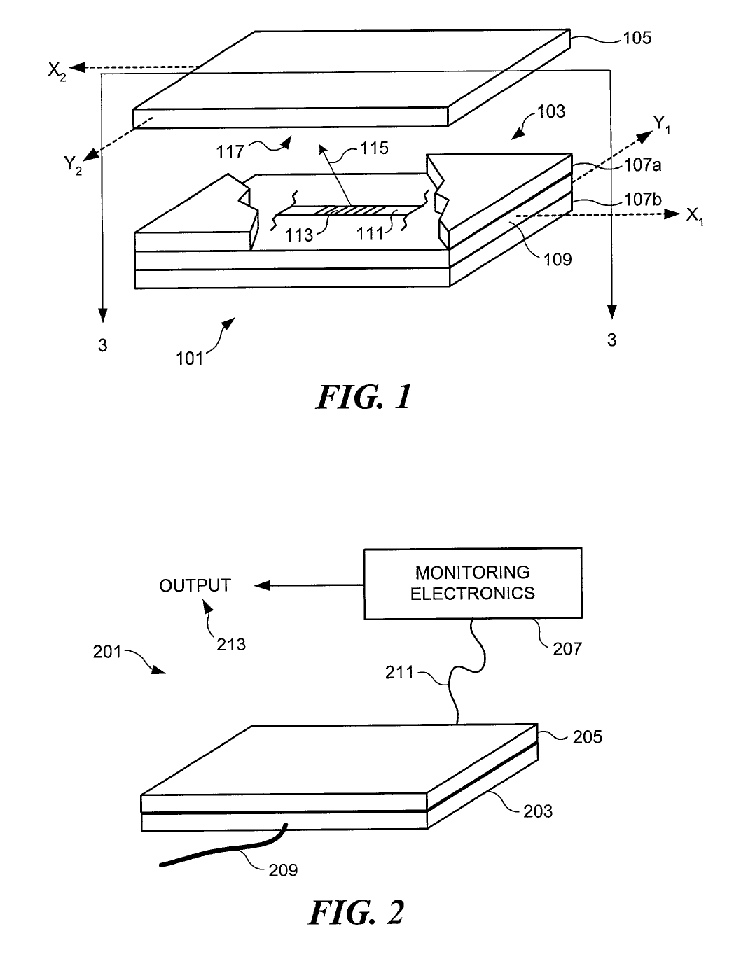

Utilization of gratings to tap a portion of the optical signal out of the plane of the optical transmission medium in accordance with embodiments of the present invention may allow for simplified processing of the PLC. Because waveguides, or the like, need not be routed to the edges of the PLC in order to monitor the optical signal therein, the introduction of gratings into the waveguides (or other optical transmission mediums) may comprise one of the last elements of a manufacturing process, thereby allowing for placement of the gratings at strategic locations where necessary for diagnostic purposes. Moreover, monitoring an optical signal by tapping at least a portion of the optical signal out of the plane of the optical transmission medium allows for the creation of a small form-factor device comprising the PLC sandwiched together with a photodetector or photodetector array, which may be mounted on a detector substrate, in an embodiment. Other features of the illustrated embodiments will be apparent to the reader from the foregoing and the appended claims, and as the detailed description and discussion is read in conjunction with the accompanying drawings. With reference now to the drawings, and in particular to FIG. 1, a partially exploded, cut-away view of an embodiment of a PLC and detector device 101 is illustrated in accordance with an embodiment of the present invention. It will be appreciated that the embodiments of the invention depicted in FIG. 1, as well as in FIGS. 2-10, are intended as examples for illustrative purposes only, and are not necessarily drawn to scale. The device 101 includes, in the illustrated embodiment, a PLC 103 comprised of a patterned higher refractive index (“RI”) layer 109 sandwiched between a first lower RI layer 107a and a second lower RI layer 107b (the first lower RI layer 107a having been cut away to reveal a portion of the patterned higher RI layer 109), and a detector substrate 105.

In one embodiment, the patterned higher RI layer 109 may comprise a plurality of optical transmission mediums 111, such as waveguides, optical fibers, or the like, capable to channel optical signals through the PLC to perform a function associated with the PLC. For example, a pattern of waveguides may be created in the higher RI layer 109 to perform a wavelength division multiplexing function, a switching function, or other like, for an optical network or other device optically coupled to the PLC. The plurality of optical transmission mediums 111 in the patterned higher RI layer 109 may be formed via any one or combination of fabrication processes known in the art. It will be appreciated that only a portion of a single optical transmission medium (see, e.g., reference numeral 111) is illustrated in FIG. 1, and that in embodiments of the present invention a plurality of such optical transmission mediums may be included.

In one embodiment, a grating 113 may be written into the optical transmission medium 111 at one or more selected locations (e.g., wherever it is desirable to measure an attribute of the optical signal propagating through the optical transmission medium) via any one of a number of known techniques. For example, the grating 113 may be written into the optical transmission medium 111 via an interference pattern technique, a phase mask technique, or other suitable process. The interference pattern technique includes splitting a beam of light (e.g., ultraviolet light) from a single source (e.g., a laser), and then recombining the light over the optical transmission medium being treated. In this manner, an interference pattern may be generated such that a period of the grating 113 may be accurately controlled. In the phase mask technique, a phase mask, positioned over the optical transmission medium being treated, diffracts a single beam of incident light resulting in interference fringes that may be controlled to produce periodic variations in the RI of the medium.

In one embodiment, the grating 113 may be configured to tap at least a portion of an optical signal 115 (e.g., a portion of the light propagating within the optical transmission medium 111) out of the optical transmission medium 111 at an angle to cause the at least a portion of the optical signal 115 to travel out of a plane (see, e.g., plane X₁, Y₁, FIG. 1) of the optical transmission medium 111. In one embodiment, reference to the plane of the optical transmission medium (X₁, Y₁) is intended to refer to the plane coinciding with the patterned higher RI layer 109. The at least a portion of the optical signal 115 may then be detected, in an embodiment, by a photodetector or other photosensitive device capable to detect optical signals from the underside 117 of the detector substrate 105, and positioned in a second plane (see, e.g., plane X₂, Y₂, FIG. 1) distinct from the plane (X₁, Y₁) of the optical transmission medium 111. In one embodiment, the photodetector may comprise a photodetector array capable to detect light of at least two distinct wavelengths.

It will be appreciated that reference to a wavelength or distinct wavelengths, as used above and throughout this description, is intended to refer to a relatively small range of wavelengths (e.g., 10 s of picometers). The actual size of the range may be dependant upon tuning characteristics of a light source (e.g., a laser) generating the optical signals, a resolving power of the grating 113, and/or a sensitivity of the photodetector or other photosensitive device used to detect the at least a portion of the optical signal tapped out of the optical transmission medium, in an embodiment.

With reference now primarily to FIG. 2, a block diagram illustration of an embodiment of an apparatus 201 for monitoring optical signals in a PLC 203 is shown in accordance with an embodiment of the present invention. In one embodiment, the apparatus 201 includes a PLC 203 optically coupled to a detector substrate 205, which may include one or more photodetectors, as will be discussed in greater detail hereinafter. The one or more photodetectors of the detector substrate 205 may be communicatively coupled, via an electrical connection 211 for example, to monitoring electronics 207 configured to monitor an attribute (e.g., a wavelength or power) of the optical signal propagating through the optical transmission medium (as detected by the photodetectors), and generate an output 213.

For example, in one embodiment, an optical signal may be input to the PLC 203 via a fiber ribbon 209, or the like, and propagate through an optical transmission medium (e.g., the optical transmission medium 111, FIG. 1) within a patterned higher RI layer (e.g., the higher RI layer 109, FIG. 1) of the PLC 203. At least a portion of the optical signal (e.g., the portion of the optical signal 115, FIG. 1) may be tapped out of the optical transmission medium (e.g., the optical transmission medium 111, FIG. 1) via a grating (e.g., the grating 113, FIG. 1) written into the optical transmission medium (e.g., the optical transmission medium 111, FIG. 1) as discussed above, in an embodiment. The at least a portion of the optical signal (e.g., the portion of the optical signal 115, FIG. 1) may then be detected by a photodetector positioned in the detector substrate 205, in an embodiment. The detected signal may in turn cause an electrical signal to be communicated to the monitoring electronics 207 to generate an output 213 corresponding to the measured attribute of the optical signal.

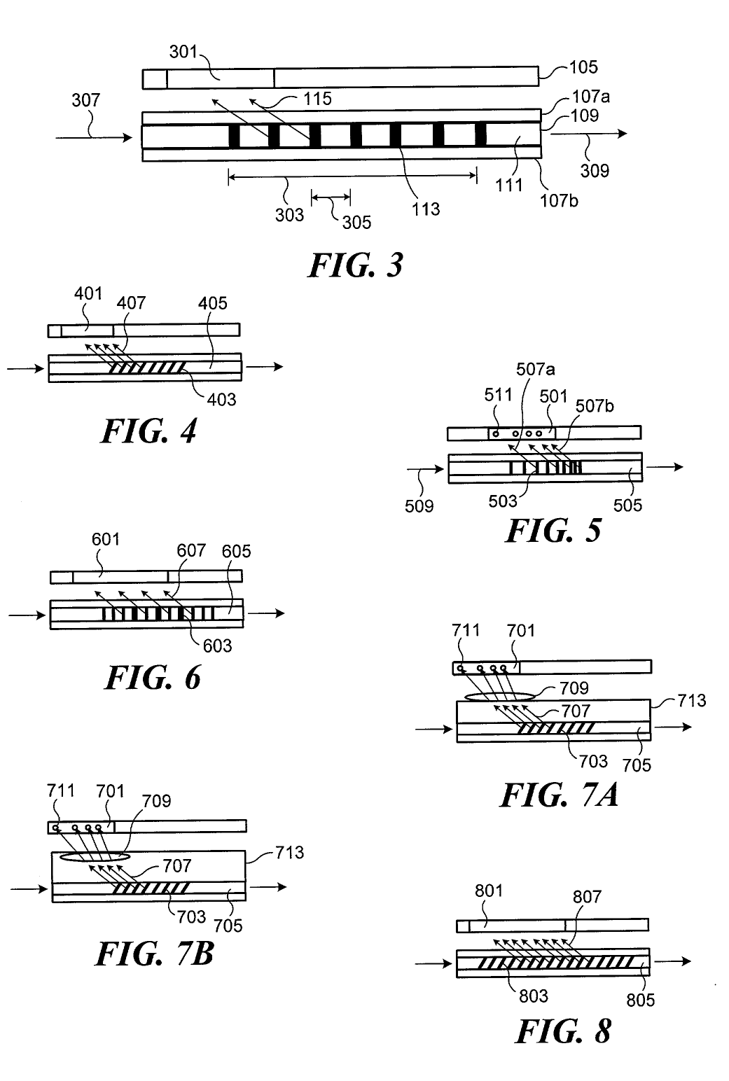

With reference now primarily to FIG. 3, a cross-sectional view, taken substantially along line 3-3 of FIG. 1, illustrating an example relationship between an embodiment of a grating 113 written into an example optical transmission medium 111 and an embodiment of a photodetector 301, is shown in accordance with an embodiment of the present invention. It will be appreciated that FIG. 3 illustrates only a portion of the detector substrate 105, the first and second lower RI layers 107a, 107b, and the patterned higher RI layer 109, also illustrated in FIG. 1. In addition, the first lower RI layer 107a is shown without being cut-away, in contrast to FIG. 1.

In one embodiment, the grating 113 may comprise a Bragg grating having a length 303 and a period 305, the period 305 being the distance between modulations of the RI in the grating 113, in an embodiment. An optical signal 307 may enter the portion of the optical transmission medium 111 having the grating 113 written therein, and at least a portion of the optical signal 115 may be tapped out of the optical transmission medium 111 via interaction with the grating 115 (e.g., via diffraction). It will be appreciated that control of the length 303 and/or RI contrast of the grating 113 may impact the amount of the optical signal (e.g., the entering optical signal 307) that is tapped out of the optical transmission medium 111 via the grating 113, in an embodiment. The at least a portion of the optical signal 115 may be reflected, in an embodiment, at an angle to cause the at least a portion of the optical signal 115 to travel out of a plane (see, e.g., the plane X₁, Y₁, FIG. 1) of the optical transmission medium 111 to the photodetector 301. In one embodiment, the photodetector 301 may be positioned in a second plane (see, e.g., the plane X₂, Y₂, FIG. 1) distinct from the plane of the optical transmission medium.

As will be appreciated, the period 305 of the grating 113 may impact the wavelength of light that is affected (e.g., diffracted or reflected) by the grating 113. Those portions of the entering optical signal 307 unaffected by the grating 113, either because of the wavelength of the signal, or the length (e.g., the length 303, FIG. 3) or RI contrast of the grating 113, may pass through the portion of the optical transmission medium 111 having the grating 113 written therein, and continue to propagate along the optical transmission medium 111, or the like, as indicated by reference numeral 309, in an embodiment. In one embodiment, the grating 113 may comprise an apodized grating in which an RI contrast may be introduced in different parts of the grating 113 over the grating length 303 to aid in shaping a spectral response of the grating 113.

With reference now primarily to FIGS. 4-8, a plurality of cross-sectional views, like FIG. 3, depicting embodiments of the invention oriented in a manner similar to that of the embodiment illustrated in FIG. 3, are shown in accordance with embodiments of the present invention. In one embodiment, and with reference primarily to FIG. 4, the grating (e.g., the grating 113, FIGS. 1, 3) may comprise a blazed grating 403 written at an oblique angle to a central axis of the optical transmission medium 405. The presence of a tilted diffraction grating (e.g., the blazed grating 403) with an angle greater than about 6 degrees from normal to the central axis of the optical transmission medium may cause light to be diffracted at an angle corresponding to approximately twice the angle of tilt of the grating. The portion of the optical signal 407 tapped out of the optical transmission medium by the blazed grating 403 may then be detected by a detector 401, positioned in a second plane (see, e.g., the plane X₂, Y₂, FIG. 1), distinct from the plane of the optical transmission medium (see, e.g., the plane X₁, Y₁, FIG. 1) in accordance with an embodiment of the present invention.

In another embodiment, and with reference primarily to FIG. 5, the grating (e.g., the grating 113, FIGS. 1, 3) may comprise a chirped grating 503 in which the period (e.g., the period 305, FIG. 3) of the grating 503 varies over the length (e.g., the length 303, FIG. 3) of the grating 503. By varying the “chirp” of the grating 503, it is possible to vary the response of the chirped grating 503 to different wavelengths of light that may comprise the optical signal 509 propagating through the optical transmission medium 505. Because different parts of the chirped grating 503 maybe configured to reflect light of different wavelengths, there maybe a wavelength-dependant delay imparted to the at least a portion of the optical signal 507 tapped out of the optical transmission medium 505 by the chirped grating 503. Different wavelength=ranges of light may be tapped out a different points along the optical transmission medium 505 depending on the period of the grating 503 and on an angle at which the grating 503 may be written (e.g., a blaze angle), thereby mapping light of different wavelengths (e.g., two or more distinct wavelengths) into a spatial position on a photodetector, or the like. The mapped wavelengths of light may then be used to qualitatively and/or quantitatively measure attributes of a plurality of optical signals propagating through the optical transmission medium 505, in an embodiment.

For example, in the embodiment illustrated in FIG. 5, light of a first wavelength 507a (e.g., longer wavelengths of light corresponding to the wider period) may be tapped out at a first position on the grating 503. Light of a second wavelength 507b (e.g., increasingly smaller and smaller wavelengths of light corresponding to the shorter and shorter periods) may then be tapped out at a second position on the grating, and so on, thereby providing a qualitative indication of the wavelength of the optical signal or signals propagating through the optical transmission medium 505 at the point at which the chirped grating 503 has been written. In one embodiment, a photodetector array 501, including a plurality of detector elements 511 and capable to detect light of at least two distinct wavelengths, may be positioned in a second plane distinct from the plane of the optical transmission medium, as described above.

It will be appreciated that, in one embodiment, the ranges of wavelengths tapped out via interaction with the chirped grating 503 may refer to two or more ranges of wavelengths that, in at least one embodiment, may overlap. For example, a first range of wavelengths may correspond to light having a wavelength of about 1550 nm to about 1580 nm, while a second range of wavelengths may correspond to light having a wavelength of about 1530 nm to about 1560 nm, in an embodiment. It will further be appreciated that the range of wavelengths may vary, in an embodiment, in conjunction with the period of the grating 503 and/or with the blaze angle of the grating 503 (see, e.g., the blazed grating 403, FIG. 4). For instance, a blaze angle of about 12 degrees from normal to the central axis of the optical transmission medium may result in a range of wavelengths spanning about 30 nm being tapped out of the optical transmission medium in conjunction with any given period of the grating 503, in an embodiment.

Furthermore, within each range of wavelengths, light of specific wavelengths (e.g., 1550 nm, 1551 nm, . . . ) may be diffracted at different angles. For example, light of a first wavelength maybe tapped out at a first angle from the grating 503, while light of a second wavelength may be tapped out at a second angle from the grating 503. A change in the period of the grating 503 (e.g., via chirping) may cause a shift in the angle at which the specific wavelengths (e.g., 1550 nm, 1551 nm, . . . ) are diffracted, assuming the specific wavelengths are present in both ranges of wavelengths (e.g., the same wavelength of light may be diffracted at different angles at different spatial positions on the grating). For instance, in one embodiment, the light of the first and second wavelengths used in the previous example may be tapped out at a third and fourth angle, respectively, the third and fourth angles differing from the first and second angles at which the first and second wavelengths were tapped out with a preceding period of the chirped grating 503. If these angles are such that the rays of light corresponding to a specific wavelength (e.g., 1550 nm) converge, they will intersect at a focal point. By tailoring the period of the chirped grating 503 to account for the diffraction of common wavelengths from successive ranges of wavelengths at different spatial positions along the chirped grating 503, the photodetector array 501 may be positioned in the focal plane to detect specific wavelengths (e.g., 1550 nm) at specific locations (e.g., 10 microns from a center of the detector array) on the photodetector array 501, therby providing both a qualitative and a quantitative indication of the optical signal passing through the optical transmission medium at the point at which the chirped grating 503 has been written.

In yet another embodiment, and with reference primarily to FIG. 6, the grating (e.g., the grating 113, FIGS. 1, 3) may comprise a phase-shifted grating 603 configured to aid in shaping a response (e.g., which wavelengths are reflected or transmitted, and in what percentage) of the grating (e.g., the grating 113, FIGS. 1, 3) in tapping at least a portion of the optical signal 607 out the optical transmission medium 605, as described above. The phase-shifted grating 603 may create a “transmission fringe” in the approximate center of a transmission band in which light is transmitted rather than reflected by the grating 603. By tailoring the grating 603 with multiple phase-shifts, in combination with other characteristics, a more defined response may be delivered by the grating 603. For example, writing the phase-shifted grating 603 with a tailored number and location of phase-shifts may allow for a more accurate measurement of attributes of the optical signal propagating through the optical transmission medium 605, in an embodiment.

With reference now primarily to FIGS. 7A and 7B, an embodiment of a blazed grating 703 written into an optical transmission medium 705 is shown in conjunction with an embodiment of a planar optical element 709 in accordance with embodiments of the present invention. In one embodiment, the planar optical element 709 may comprise a lens, and may be positioned between the optical transmission medium 705 and the photodetector 701. As illustrated in the embodiments depicted in FIGS. 7A and 7B, the photodetector 701 may comprise a photodetector array, including a plurality of detector elements 711, and capable to detect at least two distinct wavelengths of light. In one embodiment of the invention, as illustrated in FIG. 7A, the planar optical element 709 may be positioned on a surface of the first lower RI layer 713 between the optical transmission medium 705 and the photodetector array 701. For example, the planar optical element 709 may comprise a microlens or other device mounted to the surface of the first lower RI layer 713. In another embodiment of the invention, as illustrated in FIG. 7B, the planar optical element 709 may comprise an integral part of the PLC. For example, the planar optical element 709 may be constructed in the first lower RI layer 713 using standard lithography techniques known in the art.

With reference now primarily to FIG. 8, another cross-sectional view of an embodiment of a blazed grating 803 is shown in accordance with an embodiment of the present invention, illustrating an effect of lengthening the blazed grating 803, as discussed above in conjunction with FIG. 3. In the illustrated embodiment, the blazed grating 803 is written into an optical transmission medium 805 in a manner similar to that described above. However, the length (see, e.g., the length 303, FIG. 3) of the grating 803 has been increased, relative to the embodiments illustrated in FIGS. 4-7B, thereby causing a greater percentage of the optical signal 807 to be tapped out of the optical transmission medium 805, in an embodiment, to be detected by the detector 801. In one embodiment, the amount oofthe optical signal (e.g., the optical signal 807) being tapped from the optical transmission medium 805 may be accurately controlled from a few percent up to about 100 percent. In addition, increasing the length (see, e.g., the length 303, FIG. 3) of the grating (e.g., the grating 803) may produce a more defined spectral response (e.g., a narrower range of wavelengths).

It will be appreciated that any two or more of the embodiments described above may be combined in any suitable manner to tap at least a portion of an optical signal out of an optical transmission medium at an angle to cause the at least a portion of the optical signal to travel out of a plane of the optical transmission medium in accordance with an embodiment of the present invention.

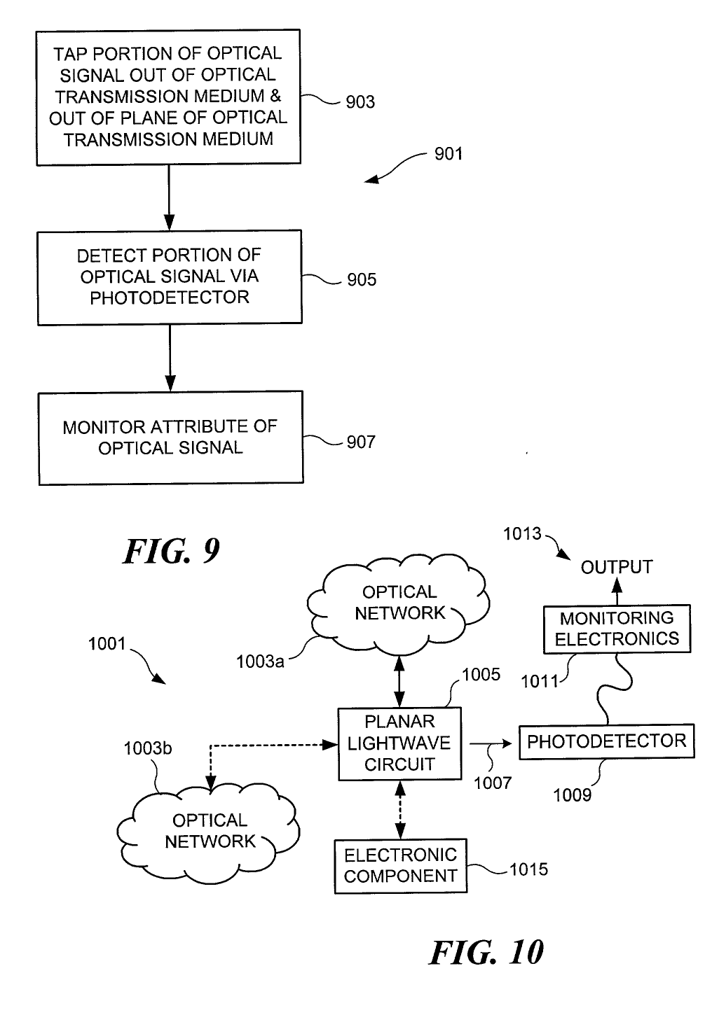

With reference now primarily to FIG. 9, a flow diagram illustrating an example flow of events in a process 901 for monitoring an attribute of an optical signal propagating through an optical transmission medium is shown in accordance with an embodiment of the present invention. In the illustrated embodiment, the process 901 begins with tapping at least a portion of the optical signal (see, e.g., reference numeral 115, FIG. 1) out of the optical transmission medium (see, e.g., reference numeral 111, FIG. 1) at an angle to cause the at least a portion of the optical signal to travel out of a plane (see, e.g., the plane X₁, Y₁, FIG. 1) of the optical transmission medium (see, e.g., process block 903). In one embodiment, the at least a portion of the optical signal may be tapped out of the optical transmission medium via interaction with a grating (see, e.g., reference numeral 113, FIG. 1), written therein, such as those described above in conjunction with, and illustrated in, FIGS. 3-8. For example, the grating may comprise a Bragg grating, and/or a blazed grating written at an oblique angle to a central axis of the optical transmission medium, in an embodiment. In other embodiments, the grating may comprise at least one of a chirped grating, an apodized grating, or a phase-shifted grating, as discussed above.

The process 901 next proceeds, in an embodiment, to detect the at least a portion of the optical signal via a photodetector, or the like (see, e.g., process block 905). In one embodiment, the photodetector may comprise a photodetector array capable to detect light of at least two distinct wavelengths, as described above in conjunction with FIGS. 5, 7A, and 7B. It will be appreciated that the photodetector may comprise any one of a number of photodetectors known in the art.

Following detection of the at least a portion of the optical signal via the photodetector (see, e.g., block 905), the process 901 proceeds to monitor an attribute (e.g., a wavelength, power, or the like) of the optical signal (see, e.g., process block 907). For example, in one embodiment, detection of the at least a portion of the optical signal at the photodetector (see, e.g., block 905) may cause generation of an electrical signal that may then be communicated to monitoring electronics (e.g., the monitoring electronics 207, FIG. 2) to generate an output (e.g., the output 213, FIG. 2) related to the attribute of the optical signal being monitored. For example, if the photodetector comprises a photodetector array, light detected at a particular spatial location on the photodetector array may generate an electrical signal to indicate that the optical signal being monitored includes a particular wavelength of light. In another embodiment, the amount of light detected at the photodetector may correspond to a power of the optical signal.

With reference now primarily to FIG. 10, a block diagram illustration of an example optical system 1001 is shown in accordance with an embodiment of the present invention. In one embodiment, the optical system 1001 includes an optical communication network 1003a optically coupled to a PLC 1005. The PLC 1005 may be optically coupled to the optical communication network 1003a via, for example, a fiber ribbon, or the like, in an embodiment. As described above, the PLC 1005 may include, in an embodiment, an optical transmission medium (see, e.g., the optical transmission medium 111, FIG. 1) having a grating (see, e.g., the grating 113, FIG. 1) written therein and configured to tap at least a portion of an optical signal 1007 (see also, e.g., the at least a portion of the optical signal 115, FIG. 1) out of the optical transmission medium. In one embodiment, the at least a portion of the optical signal 1007 may be tapped out of the optical transmission medium at an angle to cause the at least a portion of the optical transmission medium to travel out of a plane (see, e.g., the plane X₁, Y₁, FIG. 1) of the optical transmission medium, as described above in conjunction with FIGS. 1, and 3-8.

With continued reference to FIG. 10, the optical system 1001 may further include a photodetector 1009, optically coupled to the PLC 1005, and configured to detect the at least a portion of the optical signal 1007. In one embodiment, the photodetector 1009 may be positioned in a second plane (see, e.g., the second plane X₂, Y₂, FIG. 1) distinct from the plane of the optical transmission medium. In one embodiment, the photodetector 1009 may be communicatively coupled to monitoring electronics 1011 configured to monitor an attribute (e.g., at least one of a wavelength, or a power) of the optical signal propagating through the optical transmission medium at the point at which the grating has been written, and generate an output 1013 corresponding to the measured attribute.

In one embodiment, the PLC 1005 may be communicatively coupled to an electronic component 1015, such as a computer system, or the like, that may be configured to communicate via the optical communication network 1003a. In another embodiment, the PLC 1005 may be optically coupled to another optical network 1003b, which may comprise a network separate from the first optical network 1003a, or may simply comprise another part of a larger network. For example, the PLC 1005 may function as an add/drop chip capable to add and/or drop light of individual wavelengths at a point within a larger optical network including the optical network 1003a and the optical network 1003b. In other embodiments, the PLC 1005 may perform a wavelength division (de)multiplexing function associated with the electronic component 1015. It will be appreciated that the electronic component 1015 and the second optical network 1003b are illustrated as being coupled to the PLC 1005 with dashed lines to indicate that either or both may or may not be included in various embodiments of the present invention. It will be appreciated that in addition to the foregoing, any and/or all of the embodiments described above in conjunction with FIGS. 1-9 may also be incorporated into embodiments of the optical system 1001 described in conjunction with, and illustrated in, FIG. 10.

While the invention is described and illustrated here in the context of a limited number of embodiments, the invention may be embodied in many forms without departing from the spirit of the essential characteristics of the invention. The illustrated and described embodiments, including what is described in the abstract of the disclosure, are therefore to be considered in all respects as illustrative and not restrictive. The scope of the invention is indicated by the appended claims rather than by the foregoing description, and all changes which come within the meaning and range of equivalency of the claims are intended to be embraced therein.

What is claimed is:

1. A method, comprising:
tapping at least a portion of an optical signal out of an optical transmission medium at an angle to cause the at least a portion of the optical signal to travel out of a plane of the optical transmission medium, the optical transmission medium having a grating written therein and comprising an element of a planar lightwave circuit; and
detecting the at least a portion of the optical signal via a photodetector, the photodetector positioned in a second plane distinct from the plane of the optical transmission medium.

2. The method of claim 1, wherein tapping the at least a portion of the optical signal out of the optical transmission medium comprises reflecting the at least a portion of the optical signal via the grating.

3. The method of claim 1, wherein tapping the at least a portion of the optical signal out of the optical transmission medium comprises diffracting the at least a portion of the optical signal via the grating.

4. The method of claim 1, wherein tapping the at least a portion of the optical signal out of the optical transmission medium comprises tapping at least two distinct wavelengths of light out of the optical transmission medium.

5. The method of claim 4, wherein tapping at least two distinct wavelengths of light out of the optical transmission medium includes tapping light of a first wavelength out of the optical transmission medium at a first position on the grating and tapping light of a second wavelength out of the optical transmission medium at a second position on the grating.

6. The method of claim 4, wherein tapping at least two distinct wavelengths of light out of the optical transmission medium includes tapping light of a first wavelength out of the optical transmission medium at a first angle from the grating and tapping light of a second wavelength out of the optical transmission medium at a second angle from the grating.

7. The method of claim 4, wherein tapping at least two distinct wavelengths of light out of the optical transmission medium includes:
tapping light of a first and second wavelength out of the optical transmission medium at a first position on the grating and at a first and second angle from the grating, respectively; and
tapping light of the first and second wavelength out of the optical transmission medium at at least one second position on the grating and at at least a third and fourth angle from the grating, respectively,
the first and third angles and the second and fourth angles, respectively, having a relationship to cause the light of the first and second wavelengths, respectively, tapped out of the optical transmission medium at the first and second positions, to be incident upon the photodetector at a common detector element.

8. The method of claim 1, wherein detecting the at least a portion of the optical signal comprises detecting light of at least two distinct wavelengths.

9. The method of claim 1, further comprising, monitoring an attribute of the optical signal.

10. The method of claim 9, wherein the attribute of the optical signal comprises at least one of a wavelength or a power.

11. The method of claim 1, wherein the at least a portion of the optical signal varies in proportion to a length of the grating.

12. The method of claim 1, wherein the at least a portion of the optical signal varies in proportion to a strength of the grating.

13. An apparatus, comprising:
a planar lightwave circuit including an optical transmission medium, the optical transmission medium having a grating written therein, the grating to tap at least a portion of an optical signal out of the optical transmission medium at an angle to cause the at least a portion of the optical signal to travel out of a plane of the optical transmission medium; and
a photodetector to detect the at least a portion of the optical signal, the photodetector optically coupled to the planar lightwave circuit and positioned in a second plane distinct from the plane of the optical transmission medium.

14. The apparatus of claim 13, wherein the grating comprises a Bragg grating.

15. The apparatus of claim 13, wherein the grating comprises a blazed grating written at an oblique angle to a central axis of the optical transmission medium.

16. The apparatus of claim 13, wherein the grating comprises at least one of a chirped grating, an apodized grating, or a phase-shifted grating.

17. The apparatus of claim 13, wherein the photodetector comprises a photodetector array, the apparatus further comprising a planar optical element positioned between the optical transmission medium and the photodetector, the planar optical element to map light of at least one wavelength into a spatial position on the photodetector array.

18. The apparatus of claim 17, wherein the planar optical element comprises a lens.

19. The apparatus of claim 17, wherein the planar optical element comprises an integral part of the planar lightwave circuit.

20. The apparatus of claim 13, wherein the photodetector comprises a photodetector array capable to detect light of at least two distinct wavelengths.

21. The apparatus of claim 13, wherein the optical transmission medium comprises at least one of a waveguide or an optical fiber.

22. The apparatus of claim 13, further comprising monitoring electronics, the monitoring electronics communicatively coupled to the photodetector to monitor an attribute of the optical signal.

23. The apparatus of claim 22, wherein the attribute of the optical signal comprises at least one of a wavelength or a power.

24. A system, comprising:
an optical communication network;
a planar lightwave circuit, optically coupled to the optical communication network, the planar lightwave circuit including an optical transmission medium having a grating written therein, the grating to tap at least a portion of an optical signal out of the optical transmission medium at an angle to cause the at least a portion of the optical signal to travel out of a plane of the optical transmission medium; and
a photodetector to detect the at least a portion of the optical signal, the photodetector optically coupled to the planar lightwave circuit and positioned in a second plane distinct from the plane of the optical transmission medium.

25. The system of claim 24, further comprising an electronic component, communicatively coupled to the planar lightwave circuit, to communicate via the optical communication network.

26. The system of claim 24, wherein the grating comprises a Bragg blazed grating written at an oblique angle to a central axis of the optical transmission medium.

27. The system of claim 24, wherein the grating comprises at least one of a chirped grating, an apodized grating, or a phase-shifted grating.

28. The system of claim 24, wherein the photodetector comprises a photodetector array capable to detect light of at least two distinct wavelengths.

29. The system of claim 24, wherein the optical transmission medium comprises at least one of a waveguide or an optical fiber.

30. The system of claim 24, further comprising monitoring electronics, the monitoring electronics communicatively coupled to the photodetector to monitor an attribute of the optical signal, the attribute of the optical signal comprising at least one of a wavelength or a power.

31. The system of claim 24, wherein the photodetector comprises a photodetector array, the system further comprising a planar optical element positioned between the optical transmission medium and the photodetector, the planar optical element to map light of at least one wavelength into a spatial position on the photodetector array.

32. The system of claim 31, wherein the planar optical element comprises a lens.
